(19) United States
(12) Patent Application Publication
(10) Pub. No.: US 2008/0256570 A1
(43) Pub. Date: Oct. 16, 2008

(54) Method and apparatus for blocking video-on-demand and pay-per-view channels that disappear and reappear

(75) Inventors: James Duane Tenbarge, Fishers, IN (US); Bret David Hawkins, Brownsburg, IN (US)

Correspondence Address: MORGAN LEWIS & BOCKIUS LLP, 1111 PENNSYLVANIA AVENUE NW, WASHINGTON, DC, 20004, US

(73) Assignee: TTE Indianapolis

(21) Appl. No.: 11/808,847

(22) Filed: Jun. 13, 2007

(30) Foreign Application Priority Data
Apr. 11, 2007 (CN) 200710074008.2

(51) Int. Cl. H04N 7/16

(52) U.S. Cl. 725/28

(57) ABSTRACT

A method of blocking a channel that disappears and reappears includes determining whether the channel that reappeared is designated as blocked by a parental control setting that was retained when the channel disappeared, and blocking the channel if the channel is designated as blocked by the parental control setting.

This application claims the benefit of the Chinese Patent Application No. 200710074008.2 filed on Apr. 11, 2007, which is hereby incorporated by reference.

### BACKGROUND OF THE INVENTION

1. Field of the Invention

The present invention relates to channel blocking, and more particularly to a method and apparatus for blocking video-on-demand (VOD) channels and pay-per-view (PPV) channels that disappear and reappear and are sent in-the-clear with a TV including a QAM tuner without a cable card.

2. Discussion of the Related Art

When a digital TV receiver acquires a digital TV signal, it is demodulated into a stream of data packets. The data packets contain the video data, audio data, and clock signal data. The data packets also contain the program association table (PAT) and the program map table (PMT). For each program, the PAT indicates the location in the data stream of the corresponding PMT. The PMT indicates the data streams that make up each program. The PMT also indicates the location of the program clock.

In addition to these data, the data stream also includes a program and system information protocol (PSIP) table. The PSIP is the protocol used in the advanced television systems committee (ATSC) digital television standard for carrying data about each channel in the broadcast transport stream of a TV station. In particular, the PSIP contains the time and date of the program, program rating, program formats, program guide information with titles and descriptions to be decoded and displayed, and audio formats.

Most modem televisions make use of a parental control system. In such systems, the user can set parental control criteria that determine which categories of content may be viewed and which categories of content will be blocked. For regular digital channels, the digital television receiver stores and associates rating information embedded in the program with each channel in the PSIP. The rating information for each program in a particular channel is retrieved from the PSIP and is compared with the parental control settings selected by the user. If the rating information does not match the parental control settings, the channel is blocked.

When the parental control system blocks the channel from being viewed, the channel will remain blocked throughout the duration of the program or until the user changes the parental control settings. If the next program on that channel has parent control ratings that match the parental control settings set by the user, the channel will become unblocked. Consequently, channels will be automatically blocked or unblocked based on the parental control ratings of each successive program.

Televisions typically include a channel list database that contains a list of channels currently being received by the television. The channel list database provides users with a list of available channels from which to select for viewing. Regular digital channels are stable and do not disappear and reappear. Therefore, the parental control information, which includes the information whether a particular channel is blocked, will always be retained.

Video-on-demand (VOD) systems allow users to select and watch video contents over a network interactively. In particular, VOD systems either stream contents, allowing the user to view the program while the program is being downloaded, or download the program in its entirety before viewing starts. On the other hand, pay-per-view (PPV) systems allow users to purchase individual programs to be seen on TV. The main difference between PPV systems and VOD systems is that in PPV systems, the program to be shown is available at the same time to everyone, whereas in VOD systems, the program is available to the user at any time the user wants it.

PPV and VOD programs do not contain ratings information embedded in the stream. Without the ratings information embedded in the channel stream, the parental control system cannot automatically block these programs. Consequently, a user must manually go into the setup menu on the television or the profiles menu on the set top box and manually block the particular PPV or VOD channel. In addition, although the user can block all unrated channels, this is undesirable because many channels have no rating information, which is different from unrated channels.

Unlike regular digital channels, PPV channels and VOD channels disappear and reappear. For example, channels 1, 2, and 5 may be allocated to a certain frequency in the morning. In the afternoon, the cable provider may physically remove channels 1, 2, and 5 from the frequency and allocate channels 22, 23, and 26 instead, to the same frequency. When the channels are physically removed from the carrier, the channels disappear and channels are removed from the channel list database along with the parental control settings associated with these channels. If channels 1, 2, and 5 are valid digital channels, they will reappear the next day. When they reappear, they will be added to the channel list database, but the parental control information will no longer be present. Since PPV or VOD channels are typically unblocked by default, a previously blocked PPV or VOD channel would become undesirably unblocked when the channel reappears. Therefore, the parental control settings need to be manually setup again to block the channel every time the channel reappears. Otherwise, they will be unblocked by default. Accordingly, blocking PPV channels or VOD channels on a television with a QAM tuner can be problematic since these channels will appear and disappear due to the nature of the channels.

### SUMMARY OF THE INVENTION

Accordingly, the present invention is directed to a method of blocking VOD channels and PPV channels that disappear and reappear and are sent in-the-clear with a TV including a QAM tuner without a cable card that substantially obviates one or more problems due to limitations and disadvantages of the related art.

An object of the present invention is to provide a method to retain all parental control information on all channels and sub-channels when these channels disappear.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the method of blocking a channel that disappears and reappears includes determining whether the channel that reappeared is designated as blocked by a parental control setting that was retained when the channel disappeared, and blocking the channel if the channel is designated as blocked by the parental control setting.

In another aspect, a method of blocking a channel that disappears and reappears, includes determining whether the channel exists in a channel list, determining whether the channel is digital, determining whether the channel is a valid digital channel wherein the channel is a valid digital channel if the channel is marked as deleted, attempting to obtain a program map table, a program association table, and program and system information protocol data, determining whether the channel is designated as blocked by a parental control setting, and blocking the channel if the channel exists in the channel list, if the channel is a valid digital channel, if the program map table, the program association table, and the program and system information protocol data are obtained, and if the channel is designated as blocked by the parental control setting.

In yet another aspect, a method of blocking a channel that disappears and reappears includes marking a valid digital channel as deleted when the channel disappears, saving a parental control setting of the channel that has disappeared, wherein the parental control setting includes whether the channel is designated as blocked, and blocking the channel when the channel reappears if the channel is designated as blocked by the parental control setting.

In yet another aspect, a apparatus for blocking a channel that disappears and reappears, includes an input port to receive control signals from a user that identifies the channel, a memory including information regarding a channel list, parental control, and carrier frequency, a controller to determine whether the channel exists in the channel list, whether the channel is a valid digital channel in the channel list, and whether the channel is blocked in the parental control, and an output port to send control signals to a display blocking the channel according to the determinations in the controller.

In yet another aspect, an apparatus for blocking a channel that disappears and reappears includes a memory including a parental control setting of the channel that has disappeared, wherein the parental control setting includes whether the channel is designated as blocked; and a controller to block the channel when the channel reappears if the channel is designated as blocked by the parental control setting.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram of an apparatus for retaining parental control of VOD and PPV channels according to the present invention.

FIG. 2 is a flow chart of a method for retaining parental control of VOD and PPV channels according to the present invention.

### DETAILED DESCRIPTION OF THE PREFERRED EMBODIMENTS

Reference will now be made in detail to the preferred embodiments of the present invention, examples of which are illustrated in the accompanying drawings.

The present invention retains all parental controls information on all channels and sub-channels even after these channels are physically removed from the carrier frequency. In the prior art, the PPV and VOD channels are removed from the channel list database when the channels are physically removed, i.e., when the channel disappears. Accordingly, the parental control information of the channel is removed simultaneously. In the present invention, additional memory is used to save the parental control information of the channel that has disappeared wherein the parental control information saved in this additional memory includes whether the channel is blocked.

The present invention marks the channel as deleted when a valid digital channel disappears and thereafter saves the parental controls information of the channel that has disappeared in a memory. Therefore, even when the channel disappears, the channel is not deleted from the channel list database. Rather, if the channel is a valid digital channel, the channel is marked as deleted until the channel reappears and all the parental controls information is retained.

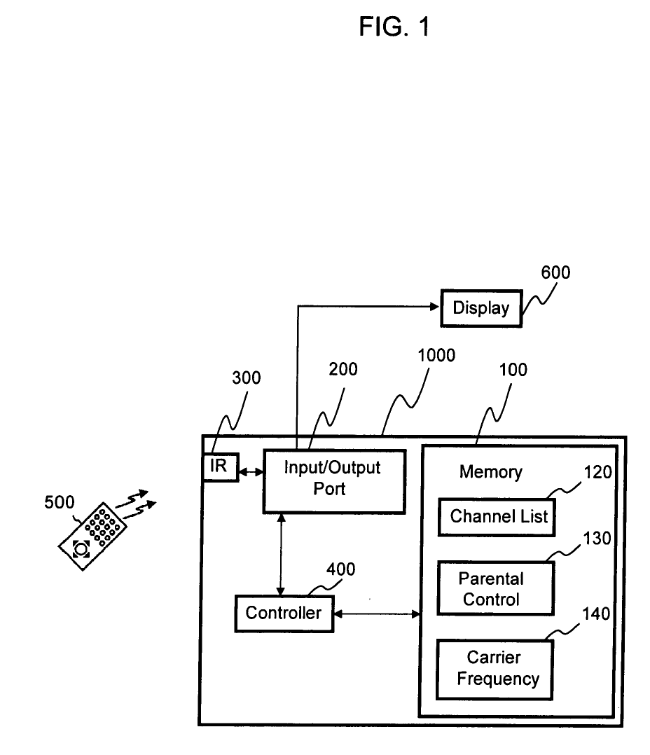

FIG. 1 is a block diagram of an apparatus 1000 for retaining parental control on VOD and PPV channels according to the present invention. As shown, a blocking apparatus includes a memory 100, an Input/Output Port 200, and an infra-red (IR) receiving device 300. Memory 100 contains storage for a channel list 120, parental control settings 130, and carrier frequency information 140. The IR receiving device 300 receives a signal from the remote control 500. The control signal received by the IR device 300 is transferred into the Input/Output Port 200. Alternatively, the control signal may also be manually input into the Input/Output Port 200 of the blocking apparatus 1000 without the use of a remote control 500. For example, the control signal may be input via a keypad coupled directly to the apparatus 1000 or remotely via a communications interface, such as a network.

The controller 400 determines whether the PAT, PMT, and PSIP data were found in the channel selected by the control signal from the Input/Output Port 200. In addition, the controller 400 retrieves the channel list database from the channel list 120 and determines whether the channel can be found in the channel list 120. If the channel is found in the channel list 120 and if the PAT, PMT, and PSIP data were found, the controller 400 further determines whether the channel is a valid digital channel by determining whether the channel is marked as deleted in the channel list 120. If the channel has been marked as deleted in the channel list 120, then the controller 400 treats the channel as a valid digital channel.

The controller 400 further determines whether the channel is blocked by determining whether there is a “blocked” designation in the parental control 130. If the channel is not blocked in the parental control 130, the controller 400 sends a command to the Input/Output Port 200 to send the content information of the channel to the display 600. On the other hand, if the channel is blocked in the parent control 130, then the controller 400 sends a command to the Input/Output Port 200 to block the audio signal and video signals from being sent to the display 600. In addition, the controller 400 sends a command to the Input/Output Port 200 to display an image showing that the channel has been blocked by the parental control. Then, the controller 400 waits for the next command from the Input/Output Port 200.

If the channel is not found in the channel list 120, then the controller 400 determines whether the PAT, PMT, and PSIP data can be found in the carrier frequency 140. If the PAT, PMT, and PSIP data can be found in the carrier frequency 140, the controller 400 sends a signal to set the parental control 130 to default values for the corresponding channel. Then, the controller 400 sends a command to the Input/Output Port 200 to send the content information of the channel to the display 600.

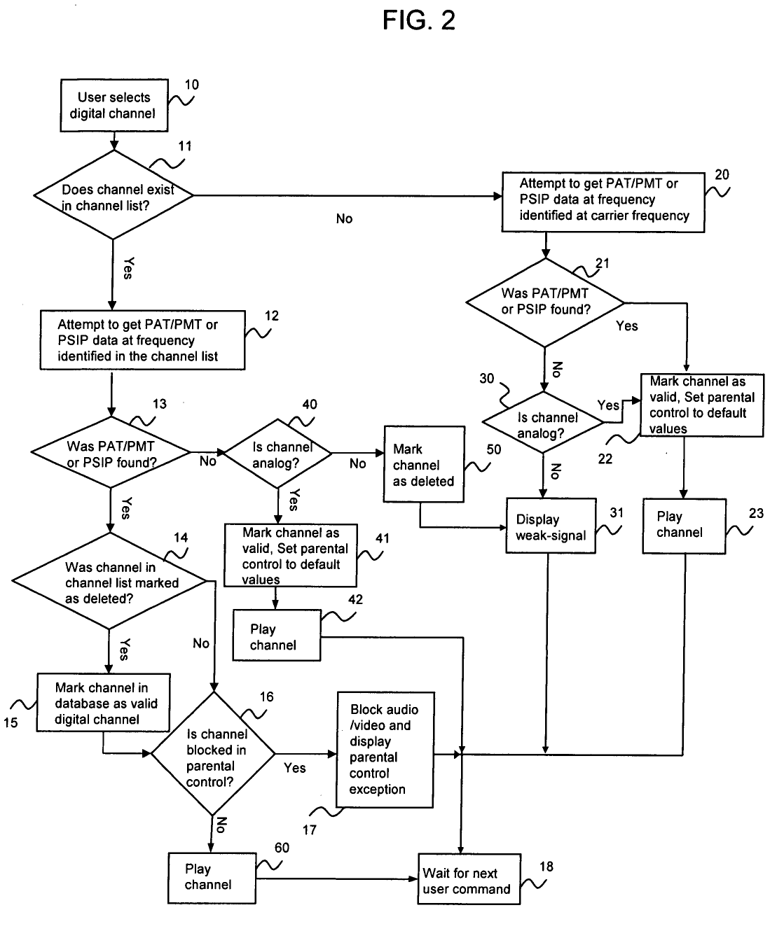

FIG. 2 is a flow chart of a method for retaining parental control of VOD and PPV channels according to the present invention. Specifically, FIG. 2 shows how the parental control information can be retained on channels when they appear after disappearing. As shown, the user first goes into the setup menu on the TV, or into the profile menu on the set top box and selects a digital channel (step 10). It is then determined whether the channel of interest exists in the channel list (step 11). If the channel can be found in the channel list, an attempt is made to obtain the PAT, PMT, and PSIP data at the identified frequency in the channel list (step 12). On the other hand, if the channel can not be found in the channel list, the attempt to obtain the PAT, PMT, and PSIP data at the identified frequency, is made at the carrier frequency (step 20).

If the channel exists in the channel list in step 11, then it is determined whether the PAT, PMT, and PSIP data were found (step 13). If they can not be found, it is further determined whether the channel is analog or digital (step 40). If the channel is not an analog channel, the channel is marked as deleted (step 50) and a weak signal is displayed (step 31). The method waits for the next command from the user (step 18). If the channel is determined to be an analog channel in step 40, the channel is marked in the database as a valid channel and the parental control is set to default values for the corresponding channel (step 41). Then, the program on the channel is played (step 42). The method waits for the next command from the user (step 18).

If the PAT, PMT, and PSIP data can be found in step 13, it is determined whether the channel is marked as deleted in the channel list (step 14). If the channel has been marked as deleted in the channel list, then the channel is marked as a valid digital channel in the database (step 15). Thereafter, it is determined whether the channel is blocked in the parental control (step 16). Similarly, if the channel was not marked in the channel list as deleted in step 14, further determination of whether the channel is blocked in the parental control is made in step 16. If the channel is not blocked in the parental controls in step 16, the channel is played (step 60). The method then waits for the next command from the user (step 18). If the channel is blocked in the parent control in step 16, then the audio signal and video signals are blocked (step 17), and the TV displays an image showing that the channel has been blocked by the parental control (step 17). Then, the method waits for the next command from the user (step 18).

If the channel does not exist in the channel list in step 11, then it is determined whether the PAT, PMT, and PSIP data were found (step 21). If they can not be found, it is further determined whether the channel is analog or digital (step 30). If the channel is not an analog channel, a weak signal is displayed (step 31) and the method then waits for the next command from the user (step 18). If the channel is determined to be an analog channel in step 30, the channel in the database is marked as a valid channel and the parental control is set to default values for the corresponding channel (step 22). Then, the channel is played (step 23), and the method further waits for the next command from the user (step 18).

If the PAT, PMT, and PSIP data were found in step 21, the channel in the database is marked and the parental control is set to default values for the corresponding channel (step 22). Then, the channel is played (step 23), and the method further waits for the next command from the user (step 18).

Accordingly, the present invention is capable of retaining all parental control information on all channels and sub-channels even when these channels disappear. These channels will be marked as deleted rather than being actually deleted from the channel list database. Therefore, when the user is surfing the channels up and down through the channel list, the channels marked as deleted will be skipped. When the sub-channel that is marked as deleted reappears at another time and when the user attempts to tune these channels, the previously applied parental control settings will be used by the television. Also, in the parental control menu, the user will be given the capability to block all sub-channels on a given frequency even if the sub-channels currently do not exist. This allows a user to block PPV or VOD programs in anticipation of their reception at a future time.

It will be apparent to those skilled in the art that various modifications and variations can be made in the method of blocking VOD channels and PPV channels that disappear and reappear of the present invention without departing from the spirit or scope of the invention. Further, it will be apparent to those of ordinary skill in the art that the present invention may be applied to a system including channels, other than PPV or VOD channels, that disappear and reapper. Thus, it is intended that the present invention cover the modifications and variations of this invention provided they come within the scope of the appended claims and their equivalents.

What is claimed is:

1. A method of blocking a channel that disappears and reappears, comprising the steps of:
determining whether the channel that reappeared is designated as blocked by a parental control setting that was retained when the channel disappeared, and
blocking the channel if the channel is designated as blocked by the parental control setting.

2. The method of claim 1, further comprising attempting to obtain a program map table, a program association table, and program and system information protocol data identified in a channel list if the channel exists in the channel list.

3. The method of claim 2, further comprising marking the channel in a database as a valid digital channel if the program map table, program association table, and program and system information protocol data are found in the channel list and the channel is marked as deleted in the channel list.

4. The method of claim 3, further comprising playing the channel and waiting for a next instruction from a user, if the channel is not blocked by the parental control setting.

5. The method of claim 3, further comprising blocking an audio and a video signal of the channel and waiting for a next instruction from a user, if the channel is blocked by the parental control setting.

6. The method of claim 3, further comprising displaying a parental control exception and waiting for next instruction from a user, if the channel is blocked by the parental control setting.

7. The method of claim 2, further comprising attempting to a get program map table, a program association table, and program and system information protocol data at a predetermined frequency identified at a carrier frequency, if the channel does not exists in the channel list.

8. A method of blocking a channel that disappears and reappears, comprising the steps of:
determining whether the channel exists in a channel list;
determining whether the channel is digital;
determining whether the channel is a valid digital channel wherein the channel is a valid digital channel if the channel is marked as deleted;
attempting to obtain a program map table, a program association table, and program and system information protocol data;
determining whether the channel is designated as blocked by a parental control setting, and
blocking the channel if the channel exists in the channel list, if the channel is a valid digital channel, if the program map table, the program association table, and the program and system information protocol data are obtained, and if the channel is designated as blocked by the parental control setting.

9. The method of claim 8, further comprising displaying a weak signal and waiting for next instruction from a user if the program map table, the program association table, and the program and system information protocol data can not be found, and if the channel is a valid digital channel.

10. The method of claim 9, wherein the channel is marked as deleted if the program map table, the program association table, and the program and system information protocol data can not be found, and if the channel is a valid digital channel.

11. The method of claim 8, further comprising marking the channel as a valid channel in a database and setting parental control to default values if the program map table, the program association table, and the program and system information protocol data are not found in the channel list and if the channel is analog.

12. The method of claim 11, further comprising playing the channel and waiting for a next instruction from a user if the channel is marked as a valid channel in the database and the parental control setting is set to default values.

13. The method of claim 8, further comprising:
attempting to the get program map table, the program association table, and the program and system information protocol data from the carrier frequency, if the channel does not exist in the channel list; and
displaying a weak signal indicator if the program map table, program association table, and program and system information protocol data are not found at the carrier frequency and the channel is analog.

14. The method of claim 8, further comprising:
attempting to the get program map table, the program association table, and the program and system information protocol data from the carrier frequency, if the channel does not exist in the channel list; and
marking the channel as a valid channel in a database and changing the parental control setting to default values if the program map table, the program association table, and the program and system information protocol data are found at the carrier frequency.

15. The method of claim 14, further comprising playing the channel and waiting for next instruction from a user if the channel is marked as a valid channel in the database and the parental control setting is set to default values.

16. A method of blocking a channel that disappears and reappears, comprising the steps of:
marking a valid digital channel as deleted when the channel disappears;
saving a parental control setting of the channel that has disappeared, wherein the parental control setting includes whether the channel is designated as blocked; and
blocking the channel when the channel reappears if the channel is designated as blocked by the parental control setting.

17. An apparatus for blocking a channel that disappears and reappears, comprising:
an input port to receive control signals from a user that identifies the channel;
a memory including information regarding a channel list, parental control setting, and carrier frequency;
a controller to determine whether the channel exists in the channel list, whether the channel is a valid digital channel in the channel list, and whether the channel is blocked in the parental control setting; and
an output port to send control signals to a display blocking the channel according to the determinations in the controller.

18. The apparatus of claim 17, wherein the controller blocks an audio and a video signal of the channel and waits for a next instruction from the input port, if the channel is blocked in the parental control setting.

19. The apparatus of claim 18, wherein the controller blocks an audio and a video signal of the channel and waits for a next instruction from the input port, if the channel is blocked in the parental control setting even when the channel has disappeared.

20. An apparatus for blocking a channel that disappears and reappears, comprising:
a memory including a parental control setting of the channel that has disappeared, wherein the parental control setting includes whether the channel is designated as blocked; and
a controller to block the channel when the channel reappears if the channel is designated as blocked by the parental control setting.
